(19) United States
(12) Patent Application Publication
(10) Pub. No.: US 2024/0098628 A1
(43) Pub. Date: Mar. 21, 2024

(54) Method and Apparatus for Relay Service Code Management

(71) Applicant: Telefonaktiebolaget LM Ericsson (publ), Stockholm (SE)

(72) Inventors: Zhang Fu, Stockholm (SE); Min Wang, Luleå (SE); Juying Gan, Shanghai (CN)

(21) Appl. No.: 18/260,950

(22) PCT Filed: Dec. 31, 2021
(86) PCT No.: PCT/CN2021/143867

§ 371 Date: Jul. 11, 2023

(30) Foreign Application Priority Data
Jan. 25, 2021 (WO) PCT/CN2021/073674

(51) Int. Cl. H04W 48/14; H04W 4/50; H04W 60/04

(52) U.S. Cl. CPC H04W 48/14; H04W 4/50; H04W 60/04; H04W 88/04

(57) ABSTRACT

Various embodiments of the present disclosure provide a method for relay service code management. The method which may be performed by a user equipment comprises transmitting a message to a first network to request a relay service code. In accordance with an exemplary embodiment, the method further comprises receiving a response to the message from the first network. The response to the message may include the RSC.

### FIELD OF THE INVENTION

The present disclosure generally relates to communication networks, and more specifically, to a method and apparatus for relay service code (RSC) management.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the evolution of wireless communication, a requirement for supporting device-to-device (D2D) communication features in various applications is proposed. An extension for the D2D work may consist of supporting vehicle-to-everything (V2X) communication, which may include any combination of direct communications among vehicles, pedestrians and infrastructure. Wireless communication networks such as fourth generation (4G)/long term evolution (LTE) and fifth generation (5G)/new radio (NR) networks may be expected to use V2X services and support communication for V2X capable user equipment (UE).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In a communication network supporting V2X services, for a remote UE in the network (NW), e.g., a UE that may be out of cell coverage and may not be able to connect with a network node directly, a UE-to-NW relay UE may provide the functionality to support connectivity to the NW for the remote UE. In some cases, the remote UE may communicate with another UE via one or more UE-to-UE relay UEs, and various traffics of the remote UE may be forwarded by the one or more UE-to-UE relays. In 4G/LTE systems, a relay service code (RSC) may be used to identify a connectivity service that a UE-to-NW relay UE provides to public safety applications. However, in 5G/NR systems, not only UE-to-NW relay but also UE-to-UE relay may provide a connectivity service. In addition, various relays in 5G/NR systems may be designed for both public safety services and commercial services. Therefore, it may be desirable to implement the management of RSCs in a more efficient way.

Various exemplary embodiments of the present disclosure propose a solution for RSC management, which can enable a UE (e.g., a remote UE, a relay UE, etc.) to get one or more RSCs from a network function/device (e.g., a direct discovery name management function (DDNMF), an application server (AS), etc.), so as to improve RSCs provisioning for commercial UE-to-NW relay and/or UE-to-UE relay discovery.

It can be appreciated that the “remote UE” described in this document may refer to a UE that may communicate with a relay UE e.g. via PC5/sidelink (SL) interface, and/or communicate with a network node e.g. via Uu interface. As an example, the remote UE may be a 5G proximity-based services (ProSe) enabled UE that may communicate with a network (NW) via a ProSe 5G UE-to-NW relay UE. As another example, the remote UE may be a 5G ProSe enabled UE that may communicate with another UE via a ProSe 5G UE-to-UE relay UE.

It can be appreciated that the terms “relay UE” and “relay” described in this document may refer to “UE-to-NW relay UE” or “UE-to-UE relay UE”. As an example, the relay UE may be a 5G ProSe enabled UE that is capable of supporting or provides functionality to support connectivity to the NW and/or other UE(s) for the remote UE.

It can be appreciated that the “UE-to-NW relay UE” described in this document may also be referred to as “UE-to-Network relay UE”, “UE-to-Network relay” and “UE-to-NW relay”. Thus, the terms “UE-to-NW relay UE”, “UE-to-Network relay UE”, “UE-to-Network relay” and “UE-to-NW relay” may be used interchangeably in this document.

It can be appreciated that the “UE-to-UE relay UE” described in this document may also be referred to as “UE-to-UE relay”. Thus, the terms “UE-to-UE relay UE” and “UE-to-UE relay” may be used interchangeably in this document.

According to a first aspect of the present disclosure, there is provided a method performed by a UE. The method comprises: transmitting a message to a first network (e.g., a 5G/NR network, etc.) to request a RSC. In accordance with an exemplary embodiment, the method further comprises: receiving a response to the message from the first network. The response to the message may include the RSC, which may be managed by a first direct discovery name manager (e.g., a DDNMF, etc.), a second direct discovery name manager (e.g., another DDNMF, etc.) or an application server (e.g., a ProSe application server, etc.).

In accordance with an exemplary embodiment, the message transmitted to the first network may include one or more of:
an identifier (ID) of the first network;
an ID of a second network;
an ID of the UE;
a role of the UE (e.g., a remote UE, a relay UE, etc.);
an application ID;
an indication of whether the RSC is used for Layer-2 relaying or Layer-3 relaying; and
an indication of whether the RSC is used for UE-to-Network relay or UE-to-UE relay.

In accordance with an exemplary embodiment, when the RSC is used for Layer-3 UE-to-Network relay, the message transmitted to the first network may include one or more of:
a protocol data unit (PDU) session type;
single network slice selection assistance information (S-NSSAI);
a data network name (DNN); and
a session and service continuity (SSC) mode for a PDU session of a relay UE.

In accordance with an exemplary embodiment, the response to the message may further include one or more of:
an ID of a second network;
an ID of the UE;
an application ID; and
an expiration time of the RSC.

In accordance with an exemplary embodiment, the first network may be a home network (e.g., a home public land mobile network (HPLMN), etc.) of the UE, and the message may be transmitted to the first direct discovery name manager for the first network.

In accordance with an exemplary embodiment, the RSC may be managed by the first direct discovery name manager, and the UE may receive the RSC from the first direct discovery name manager.

In accordance with an exemplary embodiment, the RSC may be managed by the second direct discovery name manager for a second network, and the UE may receive the RSC from the second direct discovery name manager via the first direct discovery name manager.

In accordance with an exemplary embodiment, the second network may be a network (e.g., a visiting public land mobile network (VPLMN), etc.) which may be potentially to be visited by the UE.

In accordance with an exemplary embodiment, the RSC may be managed by the application server, and the UE may receive the RSC from the first direct discovery name manager which is able to get the RSC from the application server.

In accordance with an exemplary embodiment, the UE may be a remote UE or a relay UE.

In accordance with an exemplary embodiment, for the case that the UE is a remote UE, the second network may be a home network (e.g., a HPLMN, etc.) of a relay UE which may be potentially to be connected by the remote UE.

In accordance with an exemplary embodiment, the RSC may be provisioned by the application server to an application registered to the first network.

In accordance with an exemplary embodiment, the UE may receive the RSC during registering to the first network.

In accordance with an exemplary embodiment, the UE may receive the RSC from the first network via a policy control function (PCF).

In accordance with an exemplary embodiment, the UE may transmit the message to the application server for the first network to request the RSC, and receive the RSC from the application server.

In accordance with an exemplary embodiment, the RSC may be used for a commercial application. In an embodiment, the UE may use the message to request multiple RSCs for one or more commercial applications. In another embodiment, the response to the message received by the UE may include one or multiple RSCs for one or more commercial applications.

According to a second aspect of the present disclosure, there is provided an apparatus which may be implemented as a UE. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a UE. The apparatus may comprise a transmitting unit and a receiving unit. In accordance with some exemplary embodiments, the transmitting unit may be operable to carry out at least the transmitting step of the method according to the first aspect of the present disclosure. The receiving unit may be operable to carry out at least the receiving step of the method according to the first aspect of the present disclosure.

According to a fifth aspect of the present disclosure, there is provided a method performed by a first direct discovery name manager (e.g., a DDNMF, etc.) for a first network (e.g., a home network of a UE). The method comprises: receiving a first message to request a RSC from a UE. In accordance with an exemplary embodiment, the method further comprises: transmitting a response to the first message to the UE. The response to the first message may include the RSC, which may be managed by the first direct discovery name manager, a second direct discovery name manager or an application server.

In accordance with an exemplary embodiment, the first message received by the first direct discovery name manager as described according to the fifth aspect of the present disclosure may correspond to the message transmitted by the UE as described according to the first aspect of the present disclosure. Similarly, the response to the first message transmitted by the first direct discovery name manager as described according to the fifth aspect of the present disclosure may correspond to the response to the message received by the UE as described according to the first aspect of the present disclosure.

In accordance with an exemplary embodiment, the first message may be used to request one or multiple RSCs for one or more commercial applications. Correspondingly, the response to the first message transmitted by the first direct discovery name manager may include one or multiple RSCs for one or more commercial applications.

In accordance with an exemplary embodiment, the RSC may be managed by the first direct discovery name manager.

In accordance with an exemplary embodiment, the method according to the fifth aspect of the present disclosure may further comprise: determining whether a relay service is applicable to the UE in the first network; and generating the RSC, in response to determining that the relay service is applicable to the UE in the first network.

In accordance with an exemplary embodiment, the RSC may be managed by the second direct discovery name manager for a second network. In an embodiment, the UE may be a remote UE or a relay UE, and the second network may be a network which is potentially to be visited by the UE. In another embodiment, the UE may be a remote UE, and the second network may be a home network of a relay UE which is potentially to be connected by the remote UE.

In accordance with an exemplary embodiment, the method according to the fifth aspect of the present disclosure may further comprise: determining whether a relay service is applicable to the UE in the second network. In response to determining that the relay service is applicable to the UE in the second network, the first direct discovery name manager may transmit a second message to the second network to request the RSC.

In accordance with an exemplary embodiment, the second message may include one or more of:
an ID of the second network;
an ID of the UE;
a role of the UE;
an application ID;
an indication of whether the RSC is used for Layer-2 relaying or Layer-3 relaying; and
an indication of whether the RSC is used for UE-to-Network relay or UE-to-UE relay.

In accordance with an exemplary embodiment, the first direct discovery name manager may receive a response to the second message from the second network. The response to the second message may include the RSC. In an embodiment, the response to the second message may further include one or more of: an ID of the second network, an ID of the UE, an application ID, and an expiration time of the RSC.

In accordance with an exemplary embodiment, the RSC may be managed by the application server and provisioned to an application registered to the first network.

In accordance with an exemplary embodiment, the method according to the fifth aspect of the present disclosure may further comprise: transmitting a third message to the application server to request the RSC.

In accordance with an exemplary embodiment, the method according to the fifth aspect of the present disclosure may further comprise: receiving the RSC from the application server.

According to a sixth aspect of the present disclosure, there is provided an apparatus which may be implemented as a first direct discovery name manager (e.g., a DDNMF, etc.). The apparatus may comprise one or more processors and one or more memories storing computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a first direct discovery name manager. The apparatus may comprise a receiving unit and a transmitting unit. In accordance with some exemplary embodiments, the receiving unit may be operable to carry out at least the receiving step of the method according to the fifth aspect of the present disclosure. The transmitting unit may be operable to carry out at least the transmitting step of the method according to the fifth aspect of the present disclosure.

According to a ninth aspect of the present disclosure, there is provided a method performed by a second direct discovery name manager (e.g., a DDNMF, etc.) for a second network (e.g., a target network different from a home network of a UE, etc.). The method comprises: receiving, from a first direct discovery name manager for a first network (e.g., a home network of the UE), a message to request a RSC for a UE. In accordance with an exemplary embodiment, the method further comprises: transmitting a response to the message to the first direct discovery name manager. The response to the message may include the RSC, which may be managed by the second direct discovery name manager.

In accordance with an exemplary embodiment, the message received by the second direct discovery name manager as described according to the ninth aspect of the present disclosure may correspond to the second message transmitted by the first direct discovery name manager as described according to the fifth aspect of the present disclosure. Similarly, the response to the message transmitted by the second direct discovery name manager as described according to the ninth aspect of the present disclosure may correspond to the response to the second message received by the first direct discovery name manager as described according to the fifth aspect of the present disclosure.

In accordance with an exemplary embodiment, the message received by the second direct discovery name manager may be used to request one or multiple RSCs for one or more commercial applications. Correspondingly, the response to the message transmitted by the second direct discovery name manager may include one or multiple RSCs for one or more commercial applications.

In accordance with an exemplary embodiment, when the RSC is used for Layer-3 UE-to-Network relay, the message received by the second direct discovery name manager may include one or more of:
a PDU session type;
S-NSSAI;
a DNN; and
an SSC mode for a PDU session of a relay UE.

In accordance with an exemplary embodiment, the UE may be a remote UE or a relay UE, and the second network may be a network which is potentially to be visited by the UE. In accordance with another exemplary embodiment, the UE may be a remote UE, and the second network may be a home network of a relay UE which is potentially to be connected by the remote UE.

In accordance with an exemplary embodiment, the method according to the ninth aspect of the present disclosure may further comprise: determining whether a relay service is applicable to the UE in the second network; and generating the RSC, in response to determining that the relay service is applicable to the UE in the second network.

According to a tenth aspect of the present disclosure, there is provided an apparatus which may be implemented as a second direct discovery name manager (e.g., a DDNMF, etc.). The apparatus may comprise one or more processors and one or more memories storing computer program codes. The one or more memories and the computer program codes may be configured to, with the one or more processors, cause the apparatus at least to perform any step of the method according to the ninth aspect of the present disclosure.

According to an eleventh aspect of the present disclosure, there is provided a computer-readable medium having computer program codes embodied thereon which, when executed on a computer, cause the computer to perform any step of the method according to the ninth aspect of the present disclosure.

According to a twelfth aspect of the present disclosure, there is provided an apparatus which may be implemented as a second direct discovery name manager. The apparatus may comprise a receiving unit and a transmitting unit. In accordance with some exemplary embodiments, the receiving unit may be operable to carry out at least the receiving step of the method according to the ninth aspect of the present disclosure. The transmitting unit may be operable to carry out at least the transmitting step of the method according to the ninth aspect of the present disclosure.

According to a thirteenth aspect of the present disclosure, there is provided a method performed by an application server (e.g., a ProSe application server, etc.). The method comprises: determining a RSC for an application registered to a network. In accordance with an exemplary embodiment, the method further comprises: provisioning the RSC to the network.

In accordance with an exemplary embodiment, the RSC may be provisioned to a UE (e.g., a remote UE, a relay UE, etc.) during a registration procedure of the UE for the network.

In accordance with an exemplary embodiment, the RSC may be provisioned to a UE via a PCF of the network.

In accordance with an exemplary embodiment, the method according to the thirteenth aspect of the present disclosure may further comprise: receiving a message to request the RSC for a UE from a direct discovery name manager for the network; and transmitting a response to the message to the direct discovery name manager. The response to the message may include the RSC.

In accordance with an exemplary embodiment, the method according to the thirteenth aspect of the present disclosure may further comprise: receiving a message to request the RSC from a UE; and transmitting a response to the message to the UE, wherein the response to the message includes the RSC.

In accordance with an exemplary embodiment, the message received by the application server may include one or more of:
an ID of the network;
an ID of the UE;
a role of the UE;
an application ID;
an indication of whether the RSC is used for Layer-2 relaying or Layer-3 relaying; and
an indication of whether the RSC is used for UE-to-Network relay or UE-to-UE relay.

In accordance with an exemplary embodiment, the response to the message transmitted by the application server may further include one or more of: an ID of the network, an ID of the UE, an application ID, and an expiration time of the RSC.

In accordance with an exemplary embodiment, the RSC may be one of multiple RSCs provisioned to one or more commercial applications. In accordance with another exemplary embodiment, the message received by the application server may be used to request one or more RSCs.

According to a fourteenth aspect of the present disclosure, there is provided an apparatus which may be implemented as an application server (e.g., a ProSe application server, etc.). The apparatus may comprise one or more processors and one or more memories storing computer program codes. The one or more memories and the computer program codes may be configured to, with the one or more processors, cause the apparatus at least to perform any step of the method according to the thirteenth aspect of the present disclosure.

According to a fifteenth aspect of the present disclosure, there is provided a computer-readable medium having computer program codes embodied thereon which, when executed on a computer, cause the computer to perform any step of the method according to the thirteenth aspect of the present disclosure.

According to a sixteenth aspect of the present disclosure, there is provided an apparatus which may be implemented as an application server. The apparatus may comprise a determining unit and a provisioning unit. In accordance with some exemplary embodiments, the determining unit may be operable to carry out at least the determining step of the method according to the thirteenth aspect of the present disclosure. The provisioning unit may be operable to carry out at least the provisioning step of the method according to the thirteenth aspect of the present disclosure.

According to a seventeenth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first aspect of the present disclosure.

According to an eighteenth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first aspect of the present disclosure.

According to a nineteenth aspect of the present disclosure, there is provided a method implemented in a communication system which may include a host computer, a base station and a UE. The method may comprise, at the host computer, receiving user data transmitted to the base station from the UE which may perform any step of the method according to the first aspect of the present disclosure.

According to a twentieth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first aspect of the present disclosure.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIGS. 1A-1B are diagrams illustrating exemplary ProSe function interfaces according to some embodiments of the present disclosure;

FIG. 2 is a diagram illustrating an exemplary 5G system architecture for ProSe according to an embodiment of the present disclosure;

FIGS. 3A-3C are diagrams illustrating exemplary RSC provisioning according to some embodiments of the present disclosure;

FIGS. 4A-4D are flowcharts illustrating various methods according to some embodiments of the present disclosure;

FIG. 5 is a block diagram illustrating an apparatus according to some embodiments of the present disclosure;

FIGS. 6A-6D are block diagrams illustrating various apparatuses according to some embodiments of the present disclosure;

FIG. 7 is a block diagram illustrating a telecommunication network connected via an intermediate network to a host computer in accordance with some embodiments of the present disclosure;

FIG. 8 is a block diagram illustrating a host computer communicating via a base station with a UE over a partially wireless connection in accordance with some embodiments of the present disclosure;

FIG. 9 is a flowchart illustrating a method implemented in a communication system, in accordance with an embodiment of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure; and

FIG. 12 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

3GPP specifies the LTE D2D technology, also known as ProSe (Proximity Services) in Release 12 and Release 13 of LTE. As described in clause 4.4.1 of 3GPP technical specification (TS) 23.303 V15.1.0 (where the entire content of this technical specification is incorporated into the present disclosure by reference), the ProSe function is the logical function that is used for network related actions required for ProSe. The ProSe function may play different roles for each of the features of ProSe. In 3GPP TS 23.303 V15.1.0, it is assumed that there is only one logical ProSe function in each public land mobile network (PLMN) that supports proximity services. It is noted that if multiple ProSe functions are deployed within the same PLMN (e.g., for load reasons), then the method to locate the ProSe function that has allocated a specific ProSe application code or ProSe restricted code (e.g. through a database lookup, etc.) is not defined in 3GPP TS 23.303 V15.1.0.

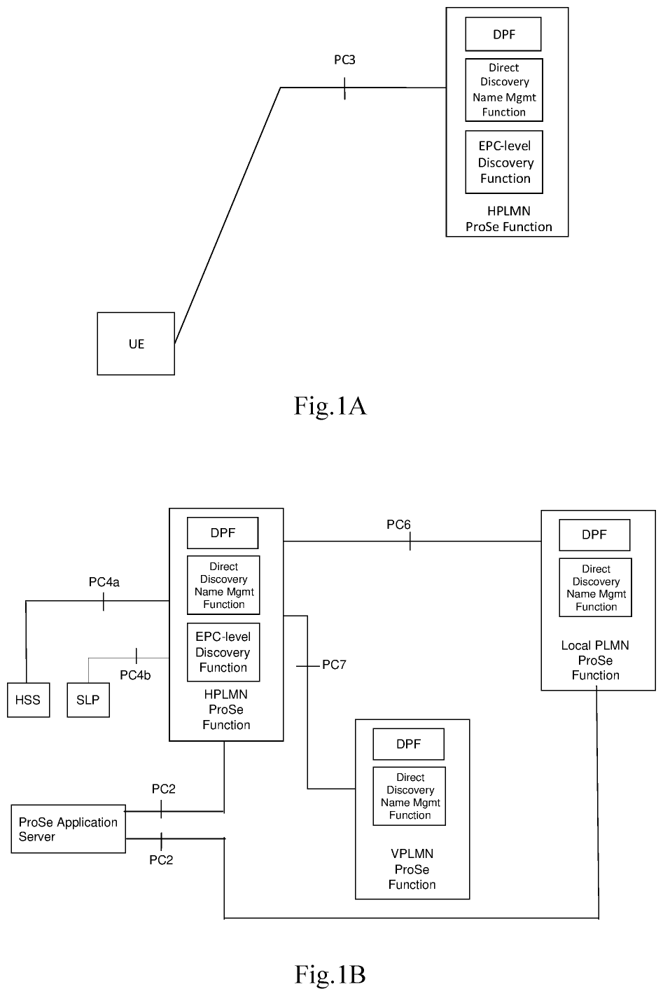

FIGS. 1A-1B are diagrams illustrating exemplary ProSe function interfaces according to some embodiments of the present disclosure. As shown in FIG. 1A, there may be a UE to ProSe function interface for each sub-function. In addition, there may be various ProSe function interfaces to other network elements and PLMNs, as shown in FIG. 1B.

The ProSe function may consist of three main sub-functions that perform different roles depending on the ProSe feature:
Direct Provisioning Function (DPF) may be used to provision the UE with necessary parameters in order use ProSe direct discovery and Prose direct communication. It may be used to provision the UEs with PLMN specific parameters that allow the UE to use ProSe in this specific PLMN. For direct communication used for public safety, the DPF may also be used to provision the UE with parameters that are needed when the UE is not served by evolved-universal terrestrial radio access network (E-UTRAN). For restricted ProSe direct discovery, the DPF may also generate and maintain the ProSe discovery UE ID (PDUID).
Direct Discovery Name Management Function (DDNMF) may be used for open Prose direct discovery to allocate and process the mapping of ProSe applications IDs and ProSe application codes used in ProSe direct discovery. It may use ProSe related subscriber data stored in a home subscriber server (HSS) for authorisation for each discovery request. It may also provide the UE with the necessary security material in order to protect discovery messages transmitted over the air. In restricted ProSe direct discovery, the DDNMF may also interact with the application server via PC2 reference points for the authorization of the discovery requests.
Evolved Packet Core-level (EPC-level) Discovery ProSe Function may have a reference point towards the application server (PC2), towards other ProSe functions (PC6), towards the HSS (PC4a) and the UE (PC3). The functionality includes the following:
   Storage of ProSe-related subscriber data and/or retrieval of ProSe-related subscriber data from the HSS;
   Authorization and configuration of the UE for EPC-level ProSe discovery and EPC-assisted wireless local area network (WLAN) direct discovery and communication over PC3;
   Storage of a list of applications that are authorized to use EPC-level ProSe discovery and EPC-assisted WLAN direct discovery and communication;
   Acting as location services client (service location protocol (SLP) agent) to enable EPC-level ProSe discovery;
   Providing the UE with information to assist WLAN direct discovery and communications;
   Handling of EPC ProSe user IDs and application layer user IDs;
   Exchange of signalling with 3rd party application servers over PC2 reference point for application registration and identifier mapping;
   Exchange of signalling with ProSe functions in other PLMNs over PC6 reference points for sending proximity requests, proximity alerts and location reporting;
   Optional support for functionality for requesting UE location via the HSS.

The ProSe function may support “on demand” announcing requested by a UE based on the operator's policy, in case of ProSe restricted discovery model A. The ProSe function may provide the necessary charging and security functionality for usage of ProSe (both ProSe via the EPC and for ProSe direct discovery, ProSe direct communication and WLAN direct discovery and communication).

The ProSe function in home public land mobile network (HPLMN) can be always reached if home routed configuration is applied for a packet data network (PDN) connection (e.g., a PDN gateway (GW) is located in the HPLMN), when such function is supported by the HPLMN. In case of local breakout (e.g., a PDN GW is located in the visiting public land mobile network (VPLMN)), a ProSe proxy function can be deployed by the VPLMN to support UE to home ProSe function communication, if inter-PLMN signaling is required. Whether a PDN connection is provided by local breakout or home routed is determined by the HSS configuration, e.g., as described in 3GPP TS 23.401 V16.9.0 (where the entire content of this technical specification is incorporated into the present disclosure by reference). The UE may not be aware of this and as such may not know which access point name (APN) can be used for communication with ProSe function unless specific APN information is configured in the UE indicating that this APN provides signaling connectivity between the UE and the home ProSe function.

As described in clause 4.5.1.1.2.3.2 of 3GPP TS 23.303 V15.1.0, the parameter provisioning for (ProSe) UE-to-Network relay discovery for public safety use case may be defined as the following:
Include the parameters that enable the UE to perform ProSe UE-to-Network relay discovery when provisioned in ME from DPF or configured in universal integrated circuit card (UICC):
User Information ID: For Model A, this corresponds to the announcer information parameter when the UE is acting as an announcing UE. For Model B, this corresponds to the discoverer information in solicitation messages and the discovery information in response messages, when the UE is acting as a discoverer or discoveree UE respectively.
Relay Service Code(s): A relay service code identifies a connectivity service the ProSe UE-to-Network relay provides to public safety applications. The relay service codes may be configured in the ProSe UE-to-Network relays that provide connectivity services to public safety applications. The relay service codes may be configured in the remote UEs interested in related connectivity services.
Alternatively, these parameters can be provided from the 3rd party public safety provider application server (e.g., a group communication service (GCS) AS as in 3GPP TS 23.468 V16.0.0, where the entire content of this technical specification is incorporated into the present disclosure by reference). If the UE receives the same set of data from AS that has been previously provided by the DPF, then the UE may use the data set provided by the AS for ProSe UE-to-Network relay discovery.

In accordance with an exemplary embodiment, as described in clause 4.6.4.3 of 3GPP TS 23.303 V15.1.0, the RSC may be defined as a parameter identifying a connectivity service the ProSe UE-to-Network relay provides to public safety applications. The RSCs may be configured in a ProSe UE-to-Network relay for advertisement. The RSCs may be configured in the remote UEs interested in related connectivity services. Additionally, the RSC may also identify authorized users the ProSe UE-to-Network relay may offer service to, and may select the related security policies or information e.g. necessary for authentication and authorization between the remote UE and the ProSe UE-to-Network relay (e.g., a RSC for relays for police members only may be different than a RSC for relays for fire fighters only, even though potentially they provide connectivity to same APN e.g. to support Internet access).

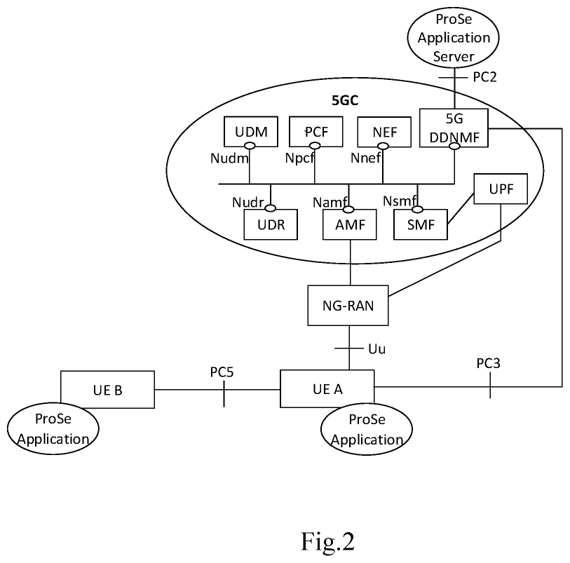

FIG. 2 is a diagram illustrating an exemplary 5G system architecture for ProSe according to an embodiment of the present disclosure. As described in clause B.2.1 of 3GPP TR 23.752 V1.0.0 (where the entire content of this technical report is incorporated into the present disclosure by reference), an architecture option named “User Plane Based Architecture” is being studies. This architecture proposes to adopt necessary function of ProSe function as defined in 3GPP TS 23.303 V15.1.0 into a 5G system architecture. According to 3GPP TS 23.303 V15.1.0, a DDNMF and a DPF of ProSe function may be needed to support ProSe in the 5G system architecture. The DPF may be used to provision the UE with necessary parameters in order to use 5G ProSe direct discovery and 5G Prose direct communication, which can be replaced by a policy control function (PCF). The DDNMF may be used to provide following procedures over PC3 interface:
Discovery Request/Response Procedure: to provide IDs and filter for direct discovery.
Match Report Procedure: to check direct discovery and provide mapping information for direct discovery.
Announcing Alert Procedure: Support ‘On-demand’ ProSe direct discovery in case of ProSe restricted discovery Model A.
Discovery Update Procedure: to update/revoke a previously allocated IDs, filters.

A 5G system (5GS) may support a service-based architecture, and the DDNMF may be network function (NF) that is not only able to interact with 5G NFs (e.g., to consume Nudm service operation) but also connects with a UE via user plane connectivity for support procedures over PC3 interface. In the architecture, it is proposed to introduce 5G DDNMF as shown in FIG. 2. In the proposed 5G system architecture for ProSe, a 5G DDNMF may be managed by a mobile network operator (MNO). The 5G DDNMF may be able to consume service operation from other NFs (e.g., Nudm or Npcf) in 5G core (5GC).

In accordance with an exemplary embodiment, PC3 interface may support a discovery request/response, a match report procedure, an announcing alert procedure, and a discovery update procedure, e.g. as described in 3GPP TS 23.303 V15.1.0. Which network slice selection assistance information (NSSAI) or data network name (DNN) to be used for user plane connectivity for PC3 interface may be up to MNO's configuration (e.g., it can be controlled by a UE route selection policy (URSP) or local configuration in the UE).

It is noted that the use case of UE-to-Network relay in 4G/LTE systems is for public safety only. Correspondingly, in a 4G system (4GS), the scenario of a remote UE accessing a 3GPP network via a UE-to-Network relay using PC5 interface, is defined for public safety services only. There is no support for UE-to-UE relay in 4G/LTE. But in 5GS, UE-to-Network relay may be applied to both public safety and commercial use cases, and UE-to-UE relay may need to be supported for both public safety services and commercial services.

In the current 5G ProSe study (e.g., 3GPP TR 23.752 V1.0.0), management mechanisms of RSC are not discussed and studied yet, especially for UE-to-UE and commercial use cases. In particular, which network function may be used to provide a RSC to a remote UE? If the remote UE is authorized to use the relay service, then how to guarantee that the remote UE and a relay UE get the same RSC, so that they can discover each other when they are in the proximity of each other.

Various exemplary embodiments of the present disclosure propose a solution for RSC management. In accordance with an exemplary embodiment, a network device/function such as 5GDDNMF or AS may take care of the management of the RSC. When the commercial application is dependent on the VPLMN, e.g., a remote UE may only connect one or more relays that are being served by some specific PLMNs, the remote UE may send a RSC request to the 5GDDNMF of its HPLMN and provide a list of VPLMNs, then the 5GDDMNF of its HPLMN may contact the 5GDDMNFs of the VPLMNs to get the RSC. The relay UE may get the RSC in the same way as the remote UE. Alternatively or additionally, when the commercial application is bound to the HPLMN of the relay UE, e.g., the remote UE may only connect to the relay UEs that belong to a specific PLMN, the remote UE may send a RSC request to the 5GDDNMF of its HPLMN, then the 5GDDMNF of its HPLMN may contact the 5GDDMNF of the PLMN bound to the application and get the RSC. The relay UE can contact the 5GDDNMF in its HPLMN to get the RSC. Alternatively or additionally, when the ProSe application server is responsible for the management of the RSC, the remote UE and the relay UE may be able to get the RSC during the registration phase or later via PCF. In an embodiment, the remote UE and the relay UE can contact the application server directly via user plane and get the RSC.

Various exemplary embodiments of the present disclosure may be applied to support RSC provisioning for commercial UE-to-Network relay and UE-to-UE relay discovery. In addition, the RSC provisioning can be controlled by a network operator if the commercial use cases are PLMN dependent.

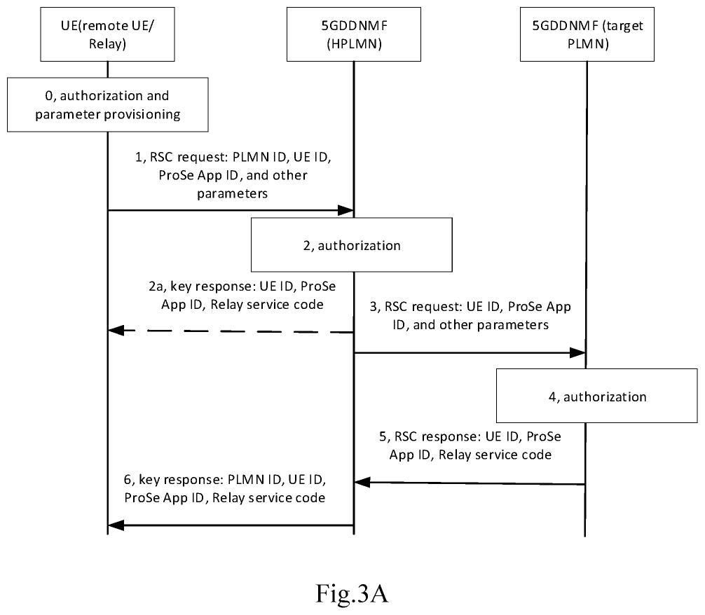

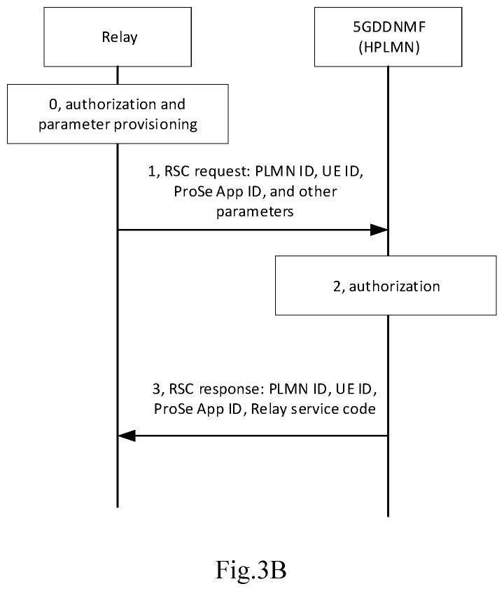

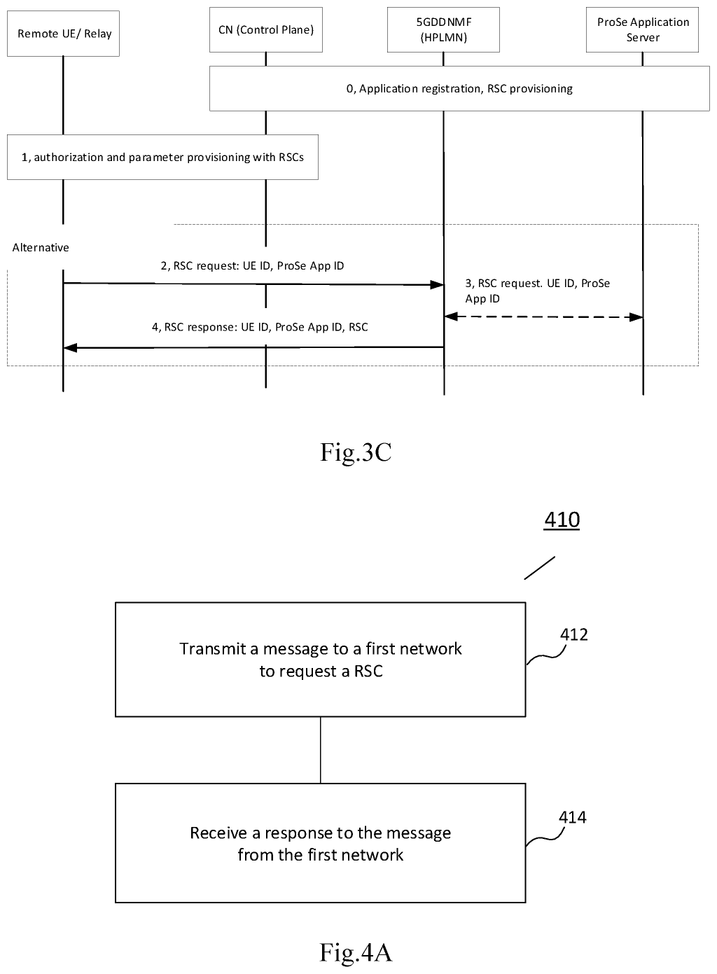

FIGS. 3A-3C are diagrams illustrating exemplary RSC provisioning according to some embodiments of the present disclosure. In accordance with an exemplary embodiment, a 5GDDNMF may be responsible for RSC management. When the commercial application are dependent on the VPLMN (also called target PLMN in this document), i.e., a remote UE may only connect to one or more relays that are being served by some specific PLMNs, the remote UE may send a RSC request message to the 5GDDNMF of its HPLMN. The message may carry an ID of the target PLMN. Then the 5GDDMNF of the remote UE's HPLMN may contact the 5GDDMNF of the target PLMN to get the RSC. The relay may get the RSC in the same way as the remote UE. FIG. 3A shows the procedure including the following steps:
Step 0: This step may be performed for authorization and parameter provisioning (e.g., the remote UE/relay may connect to the network and get authorized to be a remote UE/relay, and the remote UE/relay may also get the address of the 5GDNNMF of its HPLMN, etc.).
Step 1: The remote UE/relay may send a RSC request message to its 5GDDNMF to get the RSC. The RSC request may include at least one of the following information elements:
   PLMN ID (e.g., an ID of a target PLMN that the remote UE/relay will potentially visit, or an ID of the HPLMN of the remote UE/relay (in that case this parameter may be omitted), etc.);
   UE ID (e.g., subscription permanent identifier (SUPI), UE application ID, generic public subscription identifier (GPSI), etc.);
   UE Role (e.g., a remote UE or relay, etc.);
   ProSe application ID;
   Layer-2 relaying or Layer-3 relaying;
   UE-to-Network relay or UE-to-UE relay; and
   If the RSC is used for Layer-3 UE-to-Network relay, then one or more of the following parameters may also be included in the RSC request message:
      PDU session type;
      S-NSSAI;
      DNN; and
      SSC modes for the PDU session of the relay UE.
Step 2: The 5GDDNMF of the HPLMN of the remote UE/relay may perform authorization e.g. by checking if the remote UE/relay can consume or provide relay service in the target PLMN denoted by the PLMN ID in the RSC request. It can be appreciated that the 5GDDNMF may also contact the ProSe application server to do the authorization.
Step 2a: If the PLMN ID is the HPLMN ID or is omitted, then it is the 5GDDNMF of the HPLMN that is responsible for management of the RSC. The 5GDDNMF of the HPLMN may generate the RSC and send it (e.g., in a response including one or more other parameters such as UE ID, ProSe application ID, etc.) back to the remote UE/relay. In this case, steps 3-6 may be skipped.
Step 3: If the check in step 2 is OK (e.g., if the remote UE/relay can consume or provide relay service in the target PLMN), the 5GDDNMF in the HPLMN may send the RSC request to the 5GDDNMF of the target PLMN.
Step 4: The 5GDDNMF of the target PLMN can receive the RSC request sent by the 5GDDNMF of the HPLMN of the remote UE/relay. The 5GDDNMF of the target PLMN may perform authorization e.g. by checking if the remote UE/relay can consume or provide relay service in the target PLMN. If the check is OK, then the 5GDDNMF in the target PLMN may generate the RSC corresponding to the parameter(s) in the RSC request. It can be appreciated that the 5GDDNMF may also contact the ProSe application server to do the authorization.
Step 5: The 5GDDNMF of the target PLMN may send a RSC response message to the 5GDDNMF of the HPLMN of the remote UE/relay. The response message may include at least one of the following information elements:
   Target PLMN ID;
   UE ID;
   ProSe application ID;
   RSC; and
   Expiration time (optional) which may indicate when the RSC will be expired.
Step 6: After getting the RSC response from the target 5GDDNMF, the 5GDDNMF of the HPLMN may send the RSC response to the remote UE/relay. The RSC response message may include at least one of the following information elements:
   Target PLMN ID;
   UE ID;
   ProSe application ID;
   RSC; and
   Expiration time (optional) which may indicate when the RSC will be expired.

In accordance with an exemplary embodiment, the remote UE/relay may require different RSCs at the same time, e.g., it may request the RSCs for both UE-to-UE relay and UE-to-Network relay, then the requests for different RSCs may be combined into one request message. Correspondingly, the remote UE/relay may receive multiple RSCs in one RSC response message.

In accordance with an exemplary embodiment, a 5GDDNMF may be responsible for RSC management, and commercial applications may be dependent on the HPLMNs of the relays. In this scenario, the RSC provisioning procedure for the remote UE may be the same as described in FIG. 3A, and the PLMN ID sent in step 1 may indicate the HPLMN of the relay, i.e. the target PLMN is the HPLMN of the relay. When a 5GDDNMF receives the RSC request, it may check if the remote UE can discover the relay belonging to the corresponding PLMN. The RSC provisioning procedure for the relay in this scenario may be simpler than that for the relay in FIG. 3A, because the 5GDDNMF in the HPLMN of the relay may not need to contact a 5GDDNMF in another PLMN. FIG. 3B shows the procedure for the relay including the following steps:
Step 0: This step may be performed for authorization and parameter provisioning (e.g., a UE may connect to the network and get authorized to be a relay, and the relay may also get the address of the 5GDNNMF of its HPLMN, etc.).
Step 1: The relay may send a RSC request message to its 5GDDNMF to get the RSC. The RSC request may include at least one of the following information elements:
   PLMN ID (e.g., an ID of the HPLMN of the relay, and this parameter may be omitted);
   UE ID (e.g., SUPI, UE application ID, GPSI, etc.);
   UE Role (e.g., a relay, etc.);
   ProSe application ID;
   Layer-2 relaying or Layer-3 relaying;
   UE-to-Network relay or UE-to-UE relay; and
   If the RSC is used for Layer-3 UE-to-Network relay, then one or more of the following parameters may also be included in the RSC request message:
      PDU session type;
      S-NSSAI;
      DNN; and
      SSC modes for the PDU session of the relay.
Step 2: The 5GDDNMF may perform authorization e.g. by checking if the relay can consume or provide relay service in the HPLMN denoted by the PLMN ID in the RSC request. It can be appreciated that the 5GDDNMF may also contact the ProSe application server to do the authorization.
Step 3: If the check in step 2 is OK, the 5GDDNMF may generate the RSC and send it (e.g., in a RSC response including one or more other parameters such as PLMN ID, UE ID, ProSe application ID, etc.) back to the relay.

It can be appreciated that the PLMN ID in step 1 and step 3 may be optional, since the 5GDDNMF knows its own PLMN ID.

In accordance with an exemplary embodiment, a ProSe application server may be responsible for RSC management. FIG. 3C shows the RSC provisioning procedure including the following steps:
Step 0: This step may be performed for application registration and RSC provisioning. For a ProSe application, the corresponding ProSe application server may register the application in the 5G CN. The ProSe application server can provide one or more RSCs for the corresponding ProSe application to a unified data repository (UDR) via a network exposure function (NEF), e.g., using the Nudm_ParameterProvision_Update service and Nnef ParameterProvision_Update service.
Step 1: The authorization and parameter provisioning may happen during the remote UE/relay registration phase. For PCF based service authorization and provisioning to a UE, the registration procedures may be performed as described in clause 4.2.2.2 of 3GPP TS 23.502 V16.7.1 (where the entire content of this technical specification is incorporated into the present disclosure by reference). The PCF may get the RSC from the UDR for each of the ProSe application that the remote UE/relay is auhorized to use. An access and mobility management function (AMF) may get one or more RSCs (there may be multiple RSCs, since there may be multiple ProSe applications) from the PCF, e.g., via Npcf UEPolicyControl_Create service. The UE policy association establishment procedure may be performed as described in clause 4.16.11 of 3GPP TS 23.502 V16.7.1. It can be appreciated that for a single ProSe application, the remote UE/relay may also get multiple RSCs, corresponding to different types of relaying (e.g., L2 or L3 relaying; UE-to-UE relay or UE-to-Network relay, etc.).
Step 2: Alternatively or additionally, the remote UE/relay may contact the 5GDDNMF (e.g., in the HPLMN) via user plane and send the RSC request to the 5GDDNMF. The request may include one or more parameters such as UE ID, ProSe application ID, etc.
Step 3 (optional): If the ProSe application server does not provision the RSC to the 5G CN in step 0 or if the RSC is expired, then the 5GDDNMF may contact the corresponding ProSe application server (e.g., via PC2 interface as described in 3GPP TS 23.303 V15.1.0) to get the RSC. The 5GDDNMF may send the RSC request to the ProSe application server. The request may include one or more parameters such as UE ID, ProSe application ID, etc.
Step 4: The 5GDDNMF may provide the RSC back to the remote UE/relay, e.g., in a RSC response including one or more other parameters such as UE ID, ProSe application ID, etc.

In accordance with an exemplary embodiment, the remote UE/relay may directly contact the ProSe application server to get the RSC(s). In this case, step 2 in FIG. 3C may be performed by the remote UE/relay by sending the RSC request directly to the ProSe application server, step 3 may be omitted, and the remote UE/relay may get the RSC (s) directly from the ProSe application server in step 4.

It is noted that some embodiments of the present disclosure are mainly described in relation to 4G/LTE or 5G/NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

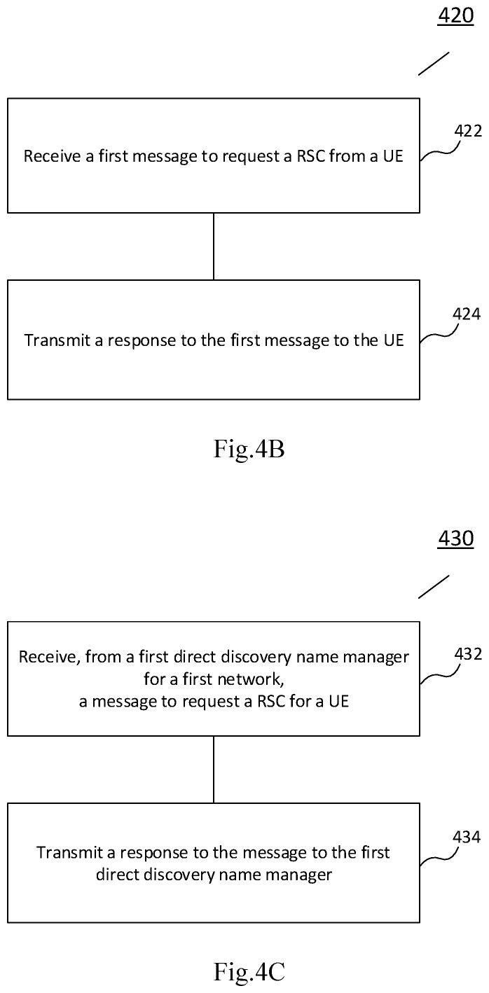

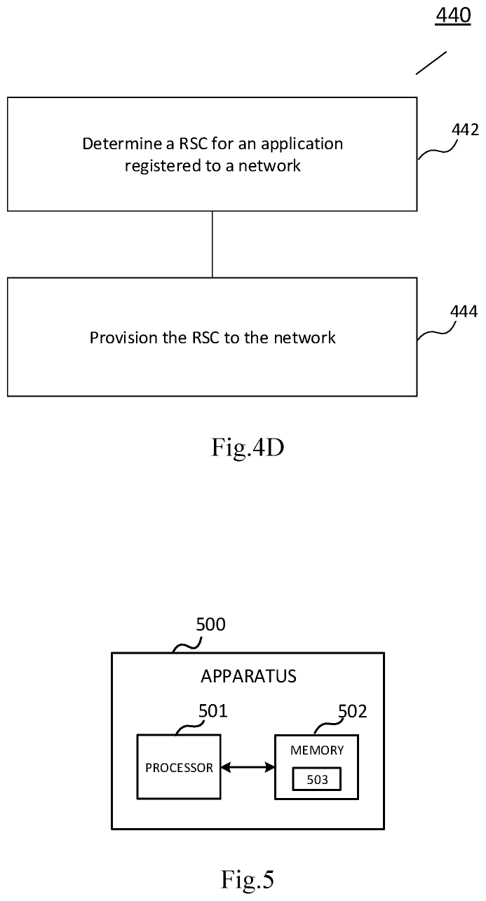

FIG. 4A is a flowchart illustrating a method 410 according to some embodiments of the present disclosure. The method 410 illustrated in FIG. 4A may be performed by a UE (e.g., a remote UE, a relay UE, etc.) or an apparatus communicatively coupled to the UE. In accordance with an exemplary embodiment, the UE may be configured to support D2D communication (e.g., V2X or sidelink communication, etc.) with other devices. In an exemplary embodiment, the UE may be configured to communicate with a network node (e.g., an eNB, a gNB, etc.) directly or via a relay.

According to the exemplary method 410 illustrated in FIG. 4A, the UE may transmit a message (e.g., a RSC request, etc.) to a first network (e.g., a home network of the UE, etc.) to request a RSC, as shown in block 412. In accordance with an exemplary embodiment, the UE may receive a response (e.g., a RSC response, etc.) to the message from the first network, as shown in block 414. The response to the message may include the RSC, which may be managed by a first direct discovery name manager (e.g., the 5GDDNMF in the HPLMN of FIG. 3A and FIG. 3B, etc.), a second direct discovery name manager (e.g., the 5GDDNMF of the target PLMN in FIG. 3A, etc.) or an application server (e.g., the ProSe application server in FIG. 3C, etc.).

In accordance with an exemplary embodiment, the message transmitted to the first network may include one or more of:
an ID of the first network (e.g., the HPLMN in FIG. 3A, FIG. 3B and FIG. 3C);
an ID of a second network (e.g., the target PLMN in FIG. 3A, the HPLMN in FIG. 3B, etc.);
an ID of the UE;
a role of the UE (e.g., a remote UE, a relay UE, etc.);
an application ID;
an indication of whether the RSC is used for Layer-2 relaying or Layer-3 relaying; and
an indication of whether the RSC is used for UE-to-Network relay or UE-to-UE relay.

In accordance with an exemplary embodiment, when the RSC is used for Layer-3 UE-to-Network relay, the message transmitted to the first network by the UE may include: a PDU session type, S-NSSAI, a DNN, and/or an SSC mode for a PDU session of a relay UE, etc.

In accordance with an exemplary embodiment, the response to the message may further include: an ID of a second network (e.g., the target PLMN in FIG. 3A, the HPLMN in FIG. 3B, etc.), an ID of the UE, an application ID, and/or an expiration time of the RSC, etc.

In accordance with an exemplary embodiment, the first network may be a home network (e.g., a HPLMN, etc.) of the UE, and the message may be transmitted from the UE to the first direct discovery name manager for the first network.

In accordance with an exemplary embodiment, the RSC may be managed by the first direct discovery name manager, and the UE may receive the RSC from the first direct discovery name manager.

In accordance with an exemplary embodiment, the RSC may be managed by the second direct discovery name manager for a second network, and the UE may receive the RSC from the second direct discovery name manager via the first direct discovery name manager.

In accordance with an exemplary embodiment, the second network may be a network (e.g., a VPLMN, etc.) which may be potentially to be visited by the UE. In accordance with another exemplary embodiment, for the case that the UE is a remote UE, the second network may be a home network (e.g., a HPLMN, etc.) of a relay UE which may be potentially to be connected by the remote UE.

In accordance with an exemplary embodiment, the RSC may be managed by the application server, and the UE may receive the RSC from the first direct discovery name manager which is able to get the RSC from the application server.

In accordance with an exemplary embodiment, the RSC may be provisioned by the application server to an application registered to the first network, e.g., as described with respect to FIG. 3C. According to an embodiment, the UE may receive the RSC during registering to the first network. Alternatively or additionally, the UE may receive the RSC from the first network via a PCF.

In accordance with an exemplary embodiment, the UE may transmit the message to the application server for the first network to request the RSC, and receive the RSC from the application server.

In accordance with an exemplary embodiment, the RSC may be used for a commercial application. According to an embodiment, the UE may use the message to request one or multiple RSCs for one or more commercial applications. According to another embodiment, the response to the message received by the UE may include one or multiple RSCs for one or more commercial applications.

FIG. 4B is a flowchart illustrating a method 420 according to some embodiments of the present disclosure. The method 420 illustrated in FIG. 4B may be performed by a first direct discovery name manager (e.g., a DDNMF, etc.) or an apparatus communicatively coupled to the first direct discovery name manager. In accordance with an exemplary embodiment, the first direct discovery name manager may be configured to support ProSe in a first network (e.g., the first network as described with respect to FIG. 4A). In accordance with another exemplary embodiment, the first direct discovery name manager may be implemented as a network function for opening ProSe direct discovery to allocate and process the mapping of ProSe applications IDs and ProSe application codes used in ProSe direct discovery.

According to the exemplary method 420 illustrated in FIG. 4B, the first direct discovery name manager may receive a first message to request a RSC from a UE (e.g., the UE as described with respect to FIG. 4A), as shown in block 422. In accordance with an exemplary embodiment, the first direct discovery name manager may transmit a response to the first message to the UE, as shown in block 424. The response to the first message may include the RSC, which may be managed by the first direct discovery name manager, a second direct discovery name manager or an application server.

It can be appreciated that the steps, operations and related configurations of the method 420 illustrated in FIG. 4B may correspond to the steps, operations and related configurations of the method 410 illustrated in FIG. 4A. It also can be appreciated that the first message received by the first direct discovery name manager according to the method 420 may correspond to the message transmitted by the UE according to the method 410. Thus, the message as described with respect to FIG. 4A and the first message as described with respect to FIG. 4B may have the same or similar contents and/or feature elements. Similarly, the response to the first message transmitted by the first direct discovery name manager according to the method 420 may correspond to the response to the message received by the UE according to the method 410. Thus, the response to the message as described with respect to FIG. 4A and the response to the first message as described with respect to FIG. 4B may have the same or similar contents and/or feature elements

In accordance with an exemplary embodiment, the first message may be used to request one or multiple RSCs for one or more commercial applications. Correspondingly, the response to the first message transmitted to the UE by the first direct discovery name manager may include one or multiple RSCs for one or more commercial applications.

In accordance with an exemplary embodiment, the first message may include one or more of:
an ID of the first network;
an ID of a second network (e.g., the second network as described with respect to FIG. 4A);
an ID of the UE;
a role of the UE;
an application ID;
an indication of whether the RSC is used for Layer-2 relaying or Layer-3 relaying; and
an indication of whether the RSC is used for UE-to-Network relay or UE-to-UE relay.

In accordance with an exemplary embodiment, when the RSC is used for Layer-3 UE-to-Network relay, the first message may include: a PDU session type, S-NSSAI, a DNN, and/or an SSC mode for a PDU session of a relay UE, etc.

In accordance with an exemplary embodiment, the response to the first message may further include: an ID of a second network (e.g., the target PLMN in FIG. 3A, etc.), an ID of the UE, an application ID, and/or an expiration time of the RSC, etc.

In accordance with an exemplary embodiment, the RSC may be managed by the first direct discovery name manager. In this case, the first direct discovery name manager may determine whether a relay service is applicable to the UE in the first network. In response to determining that the relay service is applicable to the UE in the first network, the first direct discovery name manager may generate the RSC and transmit the generated RSC to the UE.

In accordance with an exemplary embodiment, the RSC may be managed by the second direct discovery name manager for a second network (e.g., the second network node as described with respect to FIG. 4A). In an embodiment, the UE may be a remote UE or a relay UE, and the second network may be a network which is potentially to be visited by the UE. In another embodiment, the UE may be a remote UE, and the second network may be a home network of a relay UE which is potentially to be connected by the remote UE.

In accordance with an exemplary embodiment, the first direct discovery name manager may determine whether a relay service is applicable to the UE in the second network. In response to determining that the relay service is applicable to the UE in the second network, the first direct discovery name manager may transmit a second message to the second network to request the RSC.

In accordance with an exemplary embodiment, the second message may include one or more of:
an ID of the second network;
an ID of the UE;
a role of the UE;
an application ID;
an indication of whether the RSC is used for Layer-2 relaying or Layer-3 relaying; and
an indication of whether the RSC is used for UE-to-Network relay or UE-to-UE relay.

In accordance with an exemplary embodiment, the first direct discovery name manager may receive a response to the second message from the second network. The response to the second message may include the RSC. In an embodiment, the response to the second message may further include: an ID of the second network, an ID of the UE, an application ID, and/or an expiration time of the RSC, etc.

In accordance with an exemplary embodiment, the RSC may be managed by the application server and provisioned to an application registered to the first network. According to an embodiment, the first direct discovery name manager may transmit a third message (e.g., the RSC request in step 3 of FIG. 3C) to the application server to request the RSC, and receive the RSC from the application server.

FIG. 4C is a flowchart illustrating a method 430 according to some embodiments of the present disclosure. The method 430 illustrated in FIG. 4C may be performed by a second direct discovery name manager (e.g., a DDNMF, etc.) or an apparatus communicatively coupled to the second direct discovery name manager. In accordance with an exemplary embodiment, the second direct discovery name manager may be configured to support ProSe in a second network (e.g., the second network as described with respect to FIG. 4A and FIG. 4B). In accordance with another exemplary embodiment, the second direct discovery name manager may be implemented as a network function for opening ProSe direct discovery to allocate and process the mapping of ProSe applications IDs and ProSe application codes used in ProSe direct discovery.

According to the exemplary method 430 illustrated in FIG. 4C, the second direct discovery name manager may receive a message to request a RSC for a UE (the UE as described with respect to FIG. 4A), from a first direct discovery name manager (the first direct discovery name manager as described with respect to FIG. 4B) for a first network (e.g., a home network of the UE), as shown in block 432. In accordance with an exemplary embodiment, the second direct discovery name manager may transmit a response to the message to the first direct discovery name manager, as shown in block 434. The response to the message may include the RSC, which may be managed by the second direct discovery name manager.

It can be appreciated that the message received by the second direct discovery name manager according to the method 430 may correspond to the second message transmitted by the first direct discovery name manager according to the method 420. Thus, the second message as described with respect to FIG. 4B and the message as described with respect to FIG. 4C may have the same or similar contents and/or feature elements. Similarly, the response to the message transmitted by the second direct discovery name manager according to the method 430 may correspond to the response to the second message received by the first direct discovery name manager according to the method 420. Thus, the response to the second message as described with respect to FIG. 4B and the response to the message as described with respect to FIG. 4C may have the same or similar contents and/or feature elements.

In accordance with an exemplary embodiment, the message received by the second direct discovery name manager may be used to request one or multiple RSCs for one or more commercial applications. Correspondingly, the response to the message transmitted by the second direct discovery name manager may include one or multiple RSCs for one or more commercial applications.

In accordance with an exemplary embodiment, when the RSC is used for Layer-3 UE-to-Network relay, the message received by the second direct discovery name manager may include: a PDU session type, S-NSSAI, a DNN, and/or an SSC mode for a PDU session of a relay UE, etc.

In accordance with an exemplary embodiment, the UE for which the RSC is requested may be a remote UE or a relay UE, and the second network may be a network which is potentially to be visited by the UE. In accordance with another exemplary embodiment, the UE for which the RSC is requested may be a remote UE, and the second network may be a home network of a relay UE which is potentially to be connected by the remote UE.

In accordance with an exemplary embodiment, the second direct discovery name manager may determine whether a relay service is applicable to the UE in the second network. In response to determining that the relay service is applicable to the UE in the second network, the second direct discovery name manager may generate the RSC and transmit the generated RSC to the first direct discovery name manager.

It can be appreciated that the first direct discovery name manager as described with respect to FIG. 4B may also be configured to perform the method 430 as described with respect to FIG. 4C, for example, according to different service requirements and/or capabilities of the first direct discovery name manager. Similarly, the second direct discovery name manager as described with respect to FIG. 4C may also be configured to perform the method 420 as described with respect to FIG. 4B, for example, according to different service requirements and/or capabilities of the second direct discovery name manager.

FIG. 4D is a flowchart illustrating a method 440 according to some embodiments of the present disclosure. The method 440 illustrated in FIG. 4D may be performed by an application server (e.g., a ProSe application server, etc.) or an apparatus communicatively coupled to the application server. In accordance with an exemplary embodiment, the application server may be configured to support application registration and parameters provisioning in a network. In accordance with another exemplary embodiment, the application server may be configured to manage one or more RSCs for various ProSe applications.

According to the exemplary method 440 illustrated in FIG. 4D, the application server may determine a RSC for an application registered to a network (e.g., the first network and/or the second network as described with respect to FIGS. 4A-4C), as shown in block 442. In accordance with an exemplary embodiment, the application server may provision the RSC to the network, as shown in block 444.

In accordance with an exemplary embodiment, the RSC may be provisioned to a UE (e.g., the UE as described with respect to FIGS. 4A-4C) during a registration procedure of the UE for the network. Alternatively or additionally, the RSC may be provisioned to a UE (e.g., a remote UE, a relay UE, etc.) via a PCF of the network.

In accordance with an exemplary embodiment, the application server may receive a message (e.g., the third message as described with respect to FIG. 4B) to request the RSC for a UE from a direct discovery name manager (e.g., the first/second direct discovery name manager as described with respect to FIGS. 4A-4C) for the network. The application server may transmit a response to the message, e.g. including the RSC, to the direct discovery name manager.

In accordance with an exemplary embodiment, the application server may receive a message to request the RSC from a UE (e.g., the UE as described with respect to FIG. 4A) and transmit a response to the message, e.g. including the RSC, to the UE.

In accordance with an exemplary embodiment, the message received by the application server from the UE and/or the direct discovery name manager for the network may include one or more of:
an ID of the network;
an ID of the UE;
a role of the UE;
an application ID;
an indication of whether the RSC is used for Layer-2 relaying or Layer-3 relaying; and
an indication of whether the RSC is used for UE-to-Network relay or UE-to-UE relay.

In accordance with an exemplary embodiment, the response to the message transmitted by the application server may further include: an ID of the network, an ID of the UE, an application ID, and/or an expiration time of the RSC, etc.

In accordance with an exemplary embodiment, the RSC may be one of multiple RSCs provisioned to one or more commercial applications. In accordance with another exemplary embodiment, the message received from the UE and/or the direct discovery name manager by the application server may be used to request one or more RSCs.

The various blocks shown in FIGS. 4A-4D may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

FIG. 5 is a block diagram illustrating an apparatus 500 according to various embodiments of the present disclosure. As shown in FIG. 5, the apparatus 500 may comprise one or more processors such as processor 501 and one or more memories such as memory 502 storing computer program codes 503. The memory 502 may be non-transitory machine/processor/computer readable storage medium. In accordance with some exemplary embodiments, the apparatus 500 may be implemented as an integrated circuit chip or module that can be plugged or installed into a UE as described with respect to FIG. 4A, a first direct discovery name manager as described with respect to FIG. 4B, a second direct discovery name manager as described with respect to FIG. 4C, or an application server as described with respect to FIG. 4D. In such cases, the apparatus 500 may be implemented as a UE as described with respect to FIG. 4A, a first direct discovery name manager as described with respect to FIG. 4B, a second direct discovery name manager as described with respect to FIG. 4C, or an application server as described with respect to FIG. 4D.

In some implementations, the one or more memories 502 and the computer program codes 503 may be configured to, with the one or more processors 501, cause the apparatus 500 at least to perform any operation of the method as described in connection with FIG. 4A. In other implementations, the one or more memories 502 and the computer program codes 503 may be configured to, with the one or more processors 501, cause the apparatus 500 at least to perform any operation of the method as described in connection with FIG. 4B. In other implementations, the one or more memories 502 and the computer program codes 503 may be configured to, with the one or more processors 501, cause the apparatus 500 at least to perform any operation of the method as described in connection with FIG. 4C. In other implementations, the one or more memories 502 and the computer program codes 503 may be configured to, with the one or more processors 501, cause the apparatus 500 at least to perform any operation of the method as described in connection with FIG. 4D. Alternatively or additionally, the one or more memories 502 and the computer program codes 503 may be configured to, with the one or more processors 501, cause the apparatus 500 at least to perform more or less operations to implement the proposed methods according to the exemplary embodiments of the present disclosure.

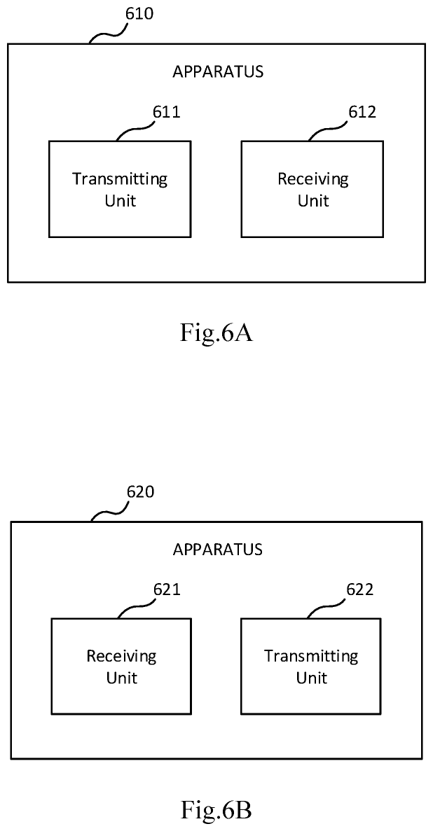

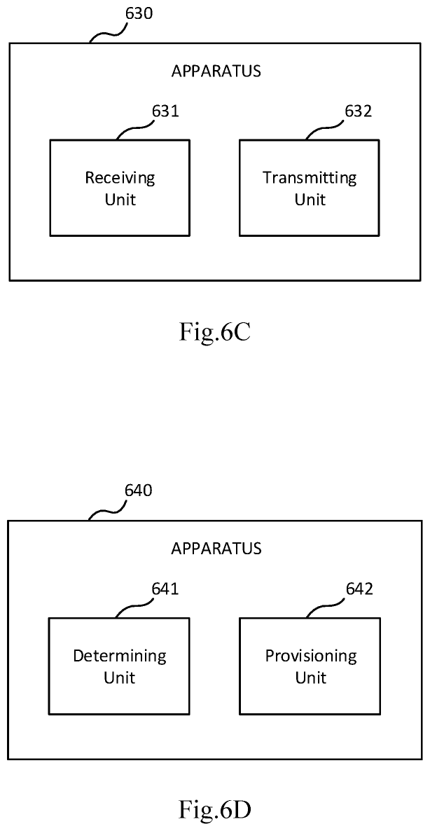

FIG. 6A is a block diagram illustrating an apparatus 610 according to some embodiments of the present disclosure. As shown in FIG. 6A, the apparatus 610 may comprise a transmitting unit 611 and a receiving unit 612. In an exemplary embodiment, the apparatus 610 may be implemented in a UE. The transmitting unit 611 may be operable to carry out the operation in block 412, and the receiving unit 612 may be operable to carry out the operation in block 414. Optionally, the transmitting unit 611 and/or the receiving unit 612 may be operable to carry out more or less operations to implement the proposed methods according to the exemplary embodiments of the present disclosure.

FIG. 6B is a block diagram illustrating an apparatus 620 according to some embodiments of the present disclosure. As shown in FIG. 6B, the apparatus 620 may comprise a receiving unit 621 and a transmitting unit 622. In an exemplary embodiment, the apparatus 620 may be implemented in a first direct discovery name manager such as a DDNMF. The receiving unit 621 may be operable to carry out the operation in block 422, and the transmitting unit 622 may be operable to carry out the operation in block 424. Optionally, the receiving unit 621 and/or the transmitting unit 622 may be operable to carry out more or less operations to implement the proposed methods according to the exemplary embodiments of the present disclosure.

FIG. 6C is a block diagram illustrating an apparatus 630 according to some embodiments of the present disclosure. As shown in FIG. 6C, the apparatus 630 may comprise a receiving unit 631 and a transmitting unit 632. In an exemplary embodiment, the apparatus 630 may be implemented in a second direct discovery name manager such as a DDNMF. The receiving unit 631 may be operable to carry out the operation in block 432, and the transmitting unit 632 may be operable to carry out the operation in block 434. Optionally, the receiving unit 631 and/or the transmitting unit 632 may be operable to carry out more or less operations to implement the proposed methods according to the exemplary embodiments of the present disclosure.

FIG. 6D is a block diagram illustrating an apparatus 640 according to some embodiments of the present disclosure. As shown in FIG. 6D, the apparatus 640 may comprise a determining unit 641 and a provisioning unit 642. In an exemplary embodiment, the apparatus 640 may be implemented in an application server such as a ProSe application server. The determining unit 641 may be operable to carry out the operation in block 442, and the provisioning unit 642 may be operable to carry out the operation in block 444. Optionally, the determining unit 641 and/or the provisioning unit 642 may be operable to carry out more or less operations to implement the proposed methods according to the exemplary embodiments of the present disclosure.

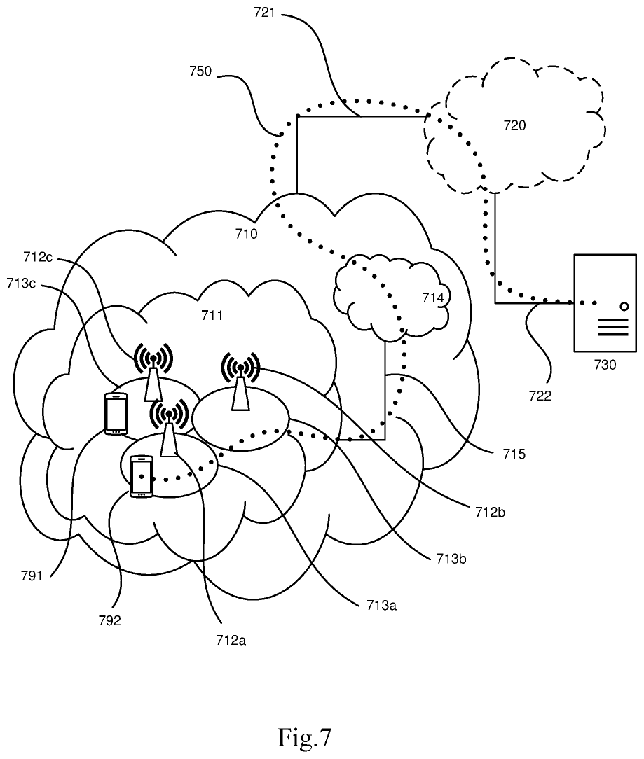

FIG. 7 is a block diagram illustrating a telecommunication network connected via an intermediate network to a host computer in accordance with some embodiments of the present disclosure.

With reference to FIG. 7, in accordance with an embodiment, a communication system includes a telecommunication network 710, such as a 3GPP-type cellular network, which comprises an access network 711, such as a radio access network, and a core network 714. The access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to the core network 714 over a wired or wireless connection 715. A first UE 791 located in a coverage area 713c is configured to wirelessly connect to, or be paged by, the corresponding base station 712c. A second UE 792 in a coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. Connections 721 and 722 between the telecommunication network 710 and the host computer 730 may extend directly from the core network 714 to the host computer 730 or may go via an optional intermediate network 720. An intermediate network 720 may be one of, or a combination of more than one of, a public, private or hosted network; the intermediate network 720, if any, may be a backbone network or the Internet; in particular, the intermediate network 720 may comprise two or more sub-networks (not shown).

The communication system of FIG. 7 as a whole enables connectivity between the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 714, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, the base station 712 may not or need not be informed about the past routing of an incoming downlink communication with data originating from the host computer 730 to be forwarded (e.g., handed over) to a connected UE 791. Similarly, the base station 712 need not be aware of the future routing of an outgoing uplink communication originating from the UE 791 towards the host computer 730.

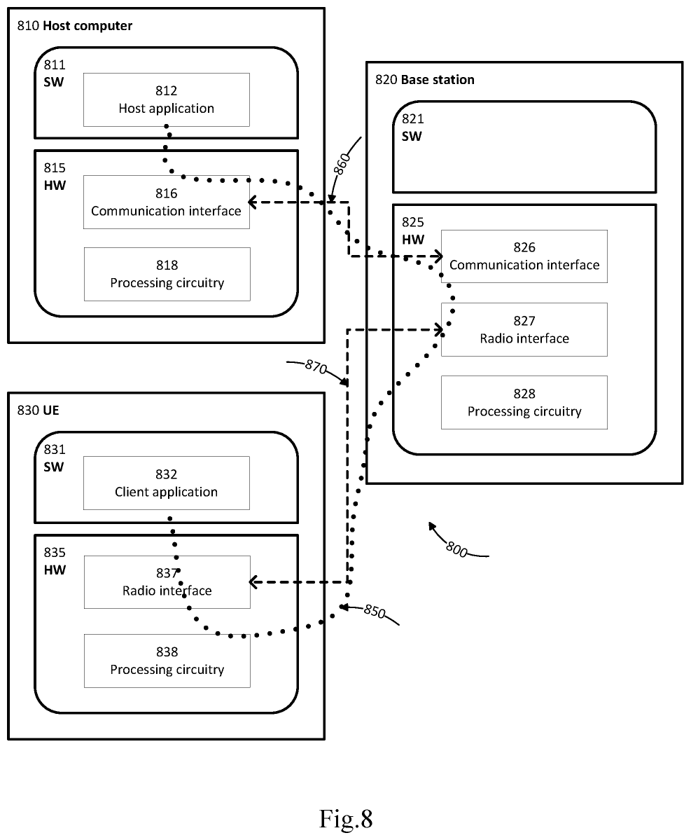

FIG. 8 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises a processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 811, which is stored in or accessible by the host computer 810 and executable by the processing circuitry 818. The software 811 includes a host application 812. The host application 812 may be operable to provide a service to a remote user, such as UE 830 connecting via an OTT connection 850 terminating at the UE 830 and the host computer 810. In providing the service to the remote user, the host application 812 may provide user data which is transmitted using the OTT connection 850.

The communication system 800 further includes a base station 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with the UE 830 located in a coverage area (not shown in FIG. 8) served by the base station 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the base station 820 further includes a processing circuitry 828, which may comprise one or more programmable processors, application-specific integrated circuits, field programmable gate arrays or combinations of these (not shown) adapted to execute instructions. The base station 820 further has software 821 stored internally or accessible via an external connection.

The communication system 800 further includes the UE 830 already referred to. Its hardware 835 may include a radio interface 837 configured to set up and maintain a wireless connection 870 with a base station serving a coverage area in which the UE 830 is currently located. The hardware 835 of the UE 830 further includes a processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, the base station 820 and the UE 830 illustrated in FIG. 8 may be similar or identical to the host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the UE 830 via the base station 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration or reconfiguration of the network).

Wireless connection 870 between the UE 830 and the base station 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 850 between the host computer 810 and the UE 830, in response to variations in the measurement results. The measurement procedure and/or the network functionality for reconfiguring the OTT connection 850 may be implemented in software 811 and hardware 815 of the host computer 810 or in software 831 and hardware 835 of the UE 830, or both. In embodiments, sensors (not shown) may be deployed in or in association with communication devices through which the OTT connection 850 passes; the sensors may participate in the measurement procedure by supplying values of the monitored quantities exemplified above, or supplying values of other physical quantities from which the software 811, 831 may compute or estimate the monitored quantities. The reconfiguring of the OTT connection 850 may include message format, retransmission settings, preferred routing etc.; the reconfiguring need not affect the base station 820, and it may be unknown or imperceptible to the base station 820. Such procedures and functionalities may be known and practiced in the art. In certain embodiments, measurements may involve proprietary UE signaling facilitating the host computer 810's measurements of throughput, propagation times, latency and the like. The measurements may be implemented in that the software 811 and 831 causes messages to be transmitted, in particular empty or ‘dummy’ messages, using the OTT connection 850 while it monitors propagation times, errors etc.

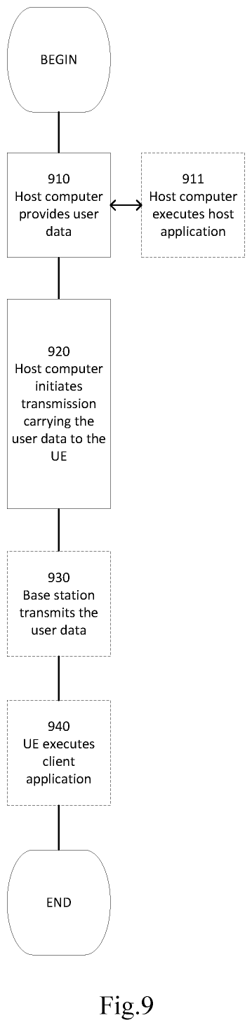

FIG. 9 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

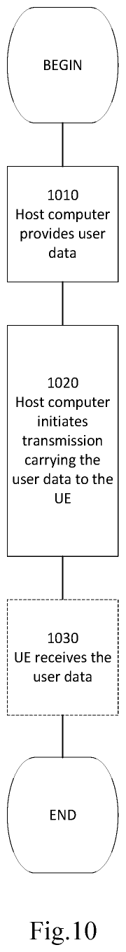

FIG. 10 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

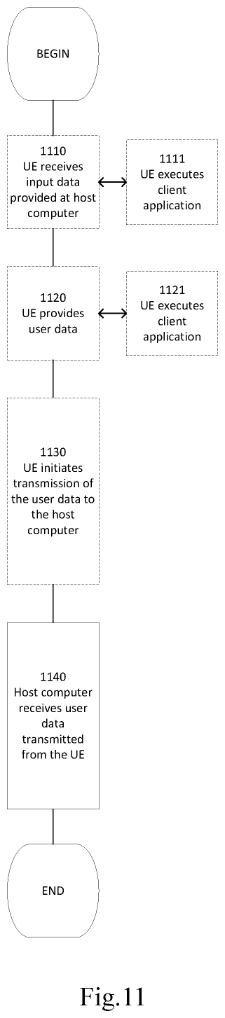

FIG. 11 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

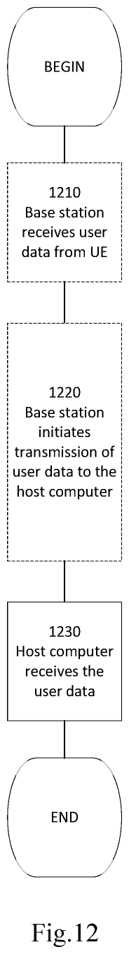

FIG. 12 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the exemplary method 410 as describe with respect to FIG. 4A.

According to some exemplary embodiments, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the exemplary method 410 as describe with respect to FIG. 4A.

According to some exemplary embodiments, there is provided a method implemented in a communication system which may include a host computer, a base station and a UE. The method may comprise, at the host computer, receiving user data transmitted to the base station from the UE which may perform any step of the exemplary method 410 as describe with respect to FIG. 4A.

According to some exemplary embodiments, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the exemplary method 410 as describe with respect to FIG. 4A.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1-41. (canceled)

42. A method performed by a user equipment (UE) comprising:
transmitting a message to a first network to request a relay service code (RSC); and
receiving a response to the message from the first network, wherein the response to the message includes the RSC, wherein the message is used to request one or more RSCs for one or more commercial applications.

43. The method according to claim 42, wherein the message includes one or more of:
an identifier (ID) of the first network;
an ID of a second network;
an ID of the UE;
a role of the UE;
an application ID;
an indication of whether the RSC is used for Layer-2 relaying or Layer-3 relaying; and
an indication of whether the RSC is used for UE-to-Network relay or UE-to-UE relay.

44. The method according to claim 42, wherein when the RSC is used for Layer-3 UE-to-Network relay, the message includes one or more of:
a protocol data unit (PDU) session type;
single network slice selection assistance information (S-NSSAI);
a data network name (DNN); and
a session and service continuity (SSC) mode for a PDU session of a relay UE.

45. The method according to claim 42, wherein the response to the message further includes one or more of:
an ID of a second network;
an ID of the UE;
an application ID; and
an expiration time of the RSC.

46. The method according to claim 42, wherein the UE receives the RSC from:
a first direct discovery name manager for the first network; or
a second direct discovery name manager for a second network via the first direct discovery name manager; or
an application server directly or via the first direct discovery name manager.

47. The method according to claim 42, wherein the RSC is provisioned by the application server to an application registered to the first network.

48. The method according to claim 42, wherein the UE receives the RSC from the first network via a policy control function (PCF).

49. A method performed by a first direct discovery name manager for a first network, comprising:
receiving a first message to request a relay service code (RSC) from a user equipment (UE); and
transmitting a response to the first message to the UE, wherein the response to the first message includes the RSC, wherein the first message is used to request one or more RSCs for one or more commercial applications.

50. The method according to claim 49, wherein the first message includes one or more of:
an identifier (ID) of the first network;
an ID of a second network;
an ID of the UE;
a role of the UE;
an application ID;
an indication of whether the RSC is used for Layer-2 relaying or Layer-3 relaying; and
an indication of whether the RSC is used for UE-to-Network relay or UE-to-UE relay.

51. The method according to claim 49, wherein when the RSC is used for Layer-3 UE-to-Network relay, the first message includes one or more of:
a protocol data unit (PDU) session type;
single network slice selection assistance information (S-NSSAI);
a data network name (DNN); and
a session and service continuity (SSC) mode for a PDU session of a relay UE.

52. The method according to claim 49, wherein the response to the first message further includes one or more of:
an ID of a second network;
an ID of the UE;
an application ID; and
an expiration time of the RSC.

53. The method according to claim 49, further comprising:
determining whether a relay service is applicable to the UE in the first network; and
generating the RSC, in response to determining that the relay service is applicable to the UE in the first network.

54. The method according to claim 49, further comprising:
determining whether a relay service is applicable to the UE in a second network;
transmitting a second message to the second network to request the RSC, in response to determining that the relay service is applicable to the UE in the second network; and
receiving a response to the second message from the second network, wherein the response to the second message includes the RSC.

55. The method according to claim 49, further comprising one or more of:
transmitting a third message to an application server to request the RSC; and
receiving the RSC from the application server.

56. A method performed by a second direct discovery name manager for a second network, the method comprising:
receiving, from a first direct discovery name manager for a first network, a message to request a relay service code (RSC) for a user equipment (UE); and
transmitting a response to the message to the first direct discovery name manager, wherein the response to the message includes the RSC, wherein the message is used to request one or more RSCs for one or more commercial applications.

57. The method according to claim 56, wherein the message includes one or more of:
an identifier (ID) of the second network;
an ID of the UE;
a role of the UE;
an application ID;
an indication of whether the RSC is used for Layer-2 relaying or Layer-3 relaying; and
an indication of whether the RSC is used for UE-to-Network relay or UE-to-UE relay.

58. The method according to claim 56, wherein when the RSC is used for Layer-3 UE-to-Network relay, the message includes one or more of:
a protocol data unit (PDU) session type;
single network slice selection assistance information (S-NSSAI);
a data network name (DNN); and
a session and service continuity (SSC) mode for a PDU session of a relay UE.

59. The method according to claim 56, wherein the response to the message further includes one or more of:
an ID of the second network;
an ID of the UE;
an application ID; and
an expiration time of the RSC.

60. The method according to claim 56, further comprising:
determining whether a relay service is applicable to the UE in the second network; and
generating the RSC, in response to determining that the relay service is applicable to the UE in the second network.

61. A method performed by an application server, comprising:
determining a relay service code (RSC) for an application registered to a network; and
provisioning the RSC to the network, wherein the RSC is one of multiple RSCs provisioned to one or more commercial applications.

62. The method according to claim 61, wherein the RSC is provisioned to a user equipment (UE) during a registration procedure of the UE for the network.

63. The method according to claim 61, wherein the RSC is provisioned to a UE via a policy control function (PCF) of the network.

64. The method according to claim 61, further comprising:
receiving a message to request the RSC for a UE from an apparatus, wherein the apparatus is the UE or a direct discovery name manager for the network; and
transmitting a response to the message to the apparatus, wherein the response to the message includes the RSC.

65. The method according to claim 64, wherein the message includes one or more of:
an identifier (ID) of the network;
an ID of the UE;
a role of the UE;
an application ID;
an indication of whether the RSC is used for Layer-2 relaying or Layer-3 relaying; and
an indication of whether the RSC is used for UE-to-Network relay or UE-to-UE relay.

66. The method according to claim 64, wherein the response to the message further includes one or more of:
an ID of the network;
an ID of the UE;
an application ID; and
an expiration time of the RSC.
